(19) United States
(12) Patent Application Publication
(10) Pub. No.: US 2010/0296298 A1
(43) Pub. Date: Nov. 25, 2010

(54) REAR-BEVELED MIRROR WITH DAY/NIGHT ADJUSTABLE BACKLIGHTING

(76) Inventor: RICHARD MASSIE MARTIN, JR., New Orleans, LA (US)

Correspondence Address: Richard Massie Martin, Jr., 20 Versailles Boulevard, New Orleans, LA, 70125, US

(21) Appl. No.: 12/761,514

(22) Filed: Apr. 16, 2010

Related U.S. Application Data
(60) Provisional application No. 61/180,500, filed on May 22, 2009.

(51) Int. Cl. F21V 3/02; F21V 3/04

(52) U.S. Cl. 362/311.06; 362/311.11

(57) ABSTRACT

A rear-beveled mirror has backlighting located near the beveled areas. The beveled areas, having the backlighting, may be located in at least two opposite sides of the mirror. The angle of the bevel may be adjusted so that the backlighting may pass through the bevel and focus on a subject standing at a typical distance away from the mirror. This typical distance may vary with the type of mirror that includes the backlighting. For example, a make-up mirror may focus the light for use from about 1-2 feet away from the mirror; and a bathroom vanity mirror may focus the light for use from about 2-4 feet away from the mirror.

### CROSS-REFERENCE TO RELATED APPLICATIONS

This application claims the benefit of U.S. provisional patent application No. 61/180,500, filed May 22, 2009, herein incorporated by reference in its entirety.

### BACKGROUND OF THE INVENTION

The present invention relates to lighting equipment and, more particularly, to a rear-beveled mirror having a direct current (“DC”) powered adjustable peripheral light emitting diode (“LED”) backlight that focuses natural wavelength light through glass or other transparent/translucent substances on a subject at a predetermined target range. The invention can be produced in a range of sizes or shapes which are appropriate for personal or commercial applications.

Conventional designs have attempted to provide proper lighting for a mirror surface for a variety of applications, including but not limited to the application of make-up, shaving, and the sale of clothing and jewelry. However, these designs are not only inefficient, they are usually dependent upon lighting which is located in positions which create shadows or which emit light wavelengths which change the apparent color of the reflected image.

As can be seen, there is a need for illumination for mirror users which may eliminate shadows and shading. In addition, there are compelling asthetic, economic, environmental and technological needs for mirrors having optimized optical lighting systems.

### SUMMARY OF THE INVENTION

In one aspect of the present invention, a lighting system comprises a translucent panel ideally having a rear-side beveled edge on at least two opposite sides of an outer periphery thereof; and a light source positioned adjacent to the rear-side beveled edge; wherein light rays from the light source intentionally focus at either a vertical line, horizontal line or a point in space located a predetermined distance from the translucent panel's surface.

In another aspect of the present invention, a mirror incorporating a rear-side beveled edge on at least two opposite sides of an outer periphery thereof; the mirroring surface being absent from the rear-side beveled edge; and a light emitting diode (“LED”) lighting strip positioned adjacent to the rear-side beveled edge; wherein light rays from the light source focus at a location in space located a predetermined distance from the translucent panel.

In a further aspect of the present invention, a method for illuminating a subject comprises passing light rays from a light source through a rear-side beveled edge of a mirror; and focusing the light rays onto the subject situated in front of the mirror; wherein the light rays are focused to a vertical line, a horizontal line or a point in space located a predetermined distance from the mirror, wherein the predetermined distance is determined from an angle of the rear-side beveled edge.

These and other features, aspects and advantages of the present invention will become better understood with reference to the following drawings, description and claims.

### BRIEF DESCRIPTION OF THE DRAWINGS

FIG. 1 is a front perspective view of a bathroom vanity/medicine cabinet mirror having a lighting design according to an exemplary embodiment of the present invention;

FIG. 2 is a front perspective view of a closet door dressing mirror having the lighting design according to another embodiment of the present invention;

FIG. 3 is a front perspective view of a makeup mirror having the lighting design according to a further embodiment of the present invention;

FIG. 4 is a cross-sectional view taken along line 4-4 of FIG. 2;

FIG. 5 is a cross-sectional view taken along line 4-4 of FIG. 2 according to an alternate embodiment of the present invention;

FIG. 5 is a schematic plan view showing the focus of light rays on a subject according to an embodiment of the present invention;

FIG. 6 is a partially exploded perspective view showing how the components of an exemplary embodiment of the present invention fit together; and

FIG. 7 is a perspective view showing the electrical components of the lighting design according to an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a rear-beveled mirror having backlighting located near the beveled areas. The beveled areas having the backlighting may be located in at least two opposite sides of the mirror. The angle of the bevel may be adjusted so that the backlighting may pass through the bevel and focus on a subject standing at a typical distance away from the mirror. This typical distance may vary with the type of mirror that includes the backlighting. For example, a make-up mirror may focus the light for use from about 1-2 feet away from the mirror; and a bathroom vanity mirror may focus the light for use from about 2-4 feet away from the mirror. The peripheral lighting system employed by the device of the present invention may provide shadowless lighting.

The lighting system of the present invention may be particularly well-suited to the needs of women of color, because it provides shadowless, full-face illumination.

In a commercial setting, this invention may afford customers true color reflections of clothing, accessories, jewelry, make-up, and any other product where discernment of color and appearance is important. The present invention may eliminate the need to discern colors by bringing objects and things outside into natural sunlight.

The present invention also addresses and cures numerous unwanted side-effects of traditional lighting systems, such as excessive electrical consumption, radiant heat production, ultraviolet light damage, and frequent light bulb replacement. Because the invention may use light emitting diodes instead of light bulbs, its electrical consumption efficiency is far greater. For the same reason, the lighting system of the present invention does not needlessly convert most of its consumed energy into heat. It may also save the expense of frequent light bulb replacement purchases because the lifespan of its light emitting diodes is approximately 50,000 hours.

From an environmental standpoint, the present invention recognizes that light bulb use has run its course in modern society. They are inefficient and obsolete. The lighting system of the present invention is an economically and environmentally beneficial device because it does not use light bulbs, does not emit harmful ultraviolet light, runs on a fraction of the energy of its incandescent counterparts, reduces utility bills, creates minimal heat byproduct, and creates virtually no fire or electrical shock risks.

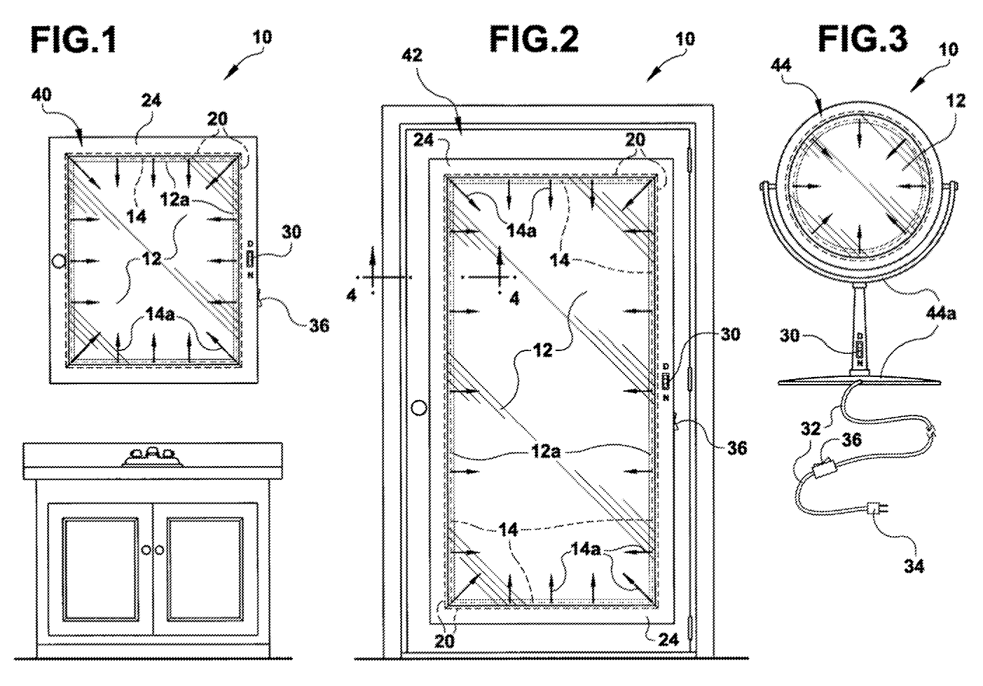

Referring to FIG. 1, a vanity mirror 12 may include a lighting system 10 according to an embodiment of the present invention. The mirror 12 may have a rear-bevel 12a around at least a portion of a periphery of the mirror 12. In the embodiment of FIG. 1, a high intensity LED lighting strip 14 may be disposed adjacent to the rear-bevel 12a. The LED lighting strip 14 may provide projected light rays 14a. The mirror 12 may be part of a medicine cabinet 40. The mirror may be circumscribed by a metal J-channel 20. A decorative molding 24 may be provided to hide the J-channel 20 and provide an aesthetically pleasing exterior appearance.

A switch 36 may interrupt and/or reduce power to the LED lighting strip 14. The switch 36 may be located at a convenient location, such as on the side of the medicine cabinet 40. The switch 36 may turn the LED lighting strip 14 on and off or the switch 36 may include a rheostat for providing a dimmer function for the LED lighting strip 14. A day/night switch 30 may be provided to adjust the power supplied to the LED lighting strip 14. For example, day/night switch 30 may adjust the output of the LED lighting strip 14 from a day use and a night use, wherein the day use setting is brighter than the night use setting.

Referring to FIG. 2, the mirror 12 of the lighting system 10 may be part of closet or dressing room door 42. In a dressing room, for example, one or more of the lighting systems 10 may be installed on the walls of the dressing room. The lighting system 10 installed in a dressing room or on a closet door may be, for example, hard-wired to an electrical power source. In one embodiment, a wall switch (not shown) may be used to turn on and off the LED lighting strips 14.

Referring to FIG. 3, the mirror 12 may be part of a makeup mirror 44. The mirror 12 may be supported by a frame 44a. A power cord 32 may be used to connect the makeup mirror 44 to a suitable power supply, such as household AC receptacle via a plug 34. The switch 36 may be, for example, in series with the power cord 32. In smaller sizes, the mirror's lighting system may be cordless and powered by rechargeable batteries, such as those suitable for lap top computers or cordless power tools. In the alternative, in smaller sizes, the mirror's lighting system may be powered by a universal service bus (“USB”) cable.

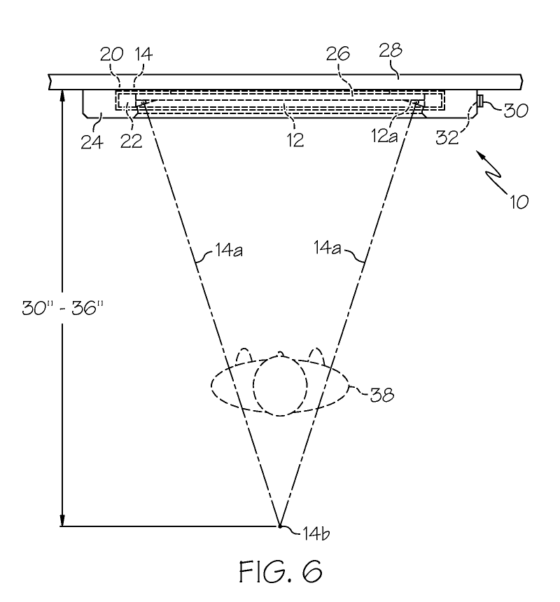

Referring to FIGS. 4 through 6, the mirror 12 may have a rear-side bevel 12a. The mirror may have a backing material 26 attached to a rear side of the mirror. The backing material 26 may extend up to but not over the rear-side bevel 12a. The backing material 26 may be wood, aluminum, a synthetic material, or the like. Behind the rear-side bevel 12a may be a lighting chamber 46. The lighting chamber 46 may house the LED lighting strips 14. The LED lighting strips 14 may attach to the backing material 26 and may be spaced from the rear-side bevel 12a of the mirror 12. This spacing may improve cooling for the LED lighting strips 14. These led lighting strips may be non-adjustable as to emitted light wavelength, or they may be variable by using red-green-blue (“RGB”) light emitting diodes. Side walls 18 of the lighting chamber 46 may include a reflective material to reflect light from the LED lighting strips 14 through the rear-side bevel 12a. The mirror 12 may be circumscribed by J-channel 20. Space between the J-channel 20 and the mirror 12 may be filled in with a filler material 22, such as a wood fill block. The J-channel 20 may be covered with a decorative molding 24. The lighting system 10 may be attached to an attachment surface 28, such as a door, wall, ceiling, or the like.

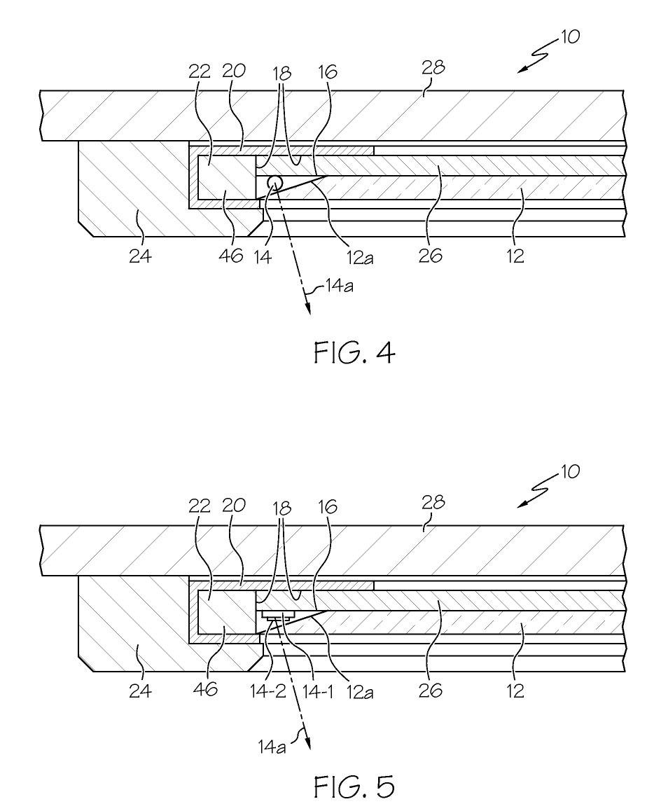

Referring specifically to FIG. 5, in one embodiment of the present invention, the LED lighting strip may be comprised of a flat, adhesive backed strip 14-1 about ½ inch wide and about 1/16 inch thick. The LED lighting strip 14-1 may be cut into specific lengths like a ribbon. In one embodiment, the LED lights 14-2 may form bumps in the LED lighting strip 14-1. As in the above embodiments, the LED lights 14-2 may have various features, such as an inter light spacing, a color temperature, a light color, a light intensity and the like, that may vary according to the indication for the mirror as well as for the requirements of the end user.

The lighting system 10 may emit focused light rays 14a toward a user 38. The light rays 14a may focus in a vertical line, a horizontal line, a plane or a point on the user 38 at a predetermined distance from the lighting system 10. For example, for a door and/or dressing room mirror, the light rays 14a may focus on the user 38 when the user 38 is from about 32 to about 36 inches from the mirror. The light rays 14a may intersect at a focal point 14b. The angle of the rear-side bevel 12a may be adjusted to vary distance the focal point 14b is from the mirror 12. For example, as the angle of the rear-side bevel 12a is reduced, the focal point 14b will move farther away from the mirror 12. The angle of the rear-side bevel 12a may vary from about 5 degrees to about 40 degrees, for example, typically from about 10 degrees to about 30 degrees. The angle of the rear-side bevel 12a may be different on different sides of the mirror 12. For example, a left side of the mirror 12 may have an angle of the rear-side bevel 12a of 10 degrees while a right side of the mirror 12 may have an angle of the rear-side bevel 12a of 20 degrees. This example may also be true of top and bottom bevels, which may be equal or unequal angles. The resulting point where the light rays 14a focuses may be shifted to the left as compared to the design where both sides have angles of 20 degrees.

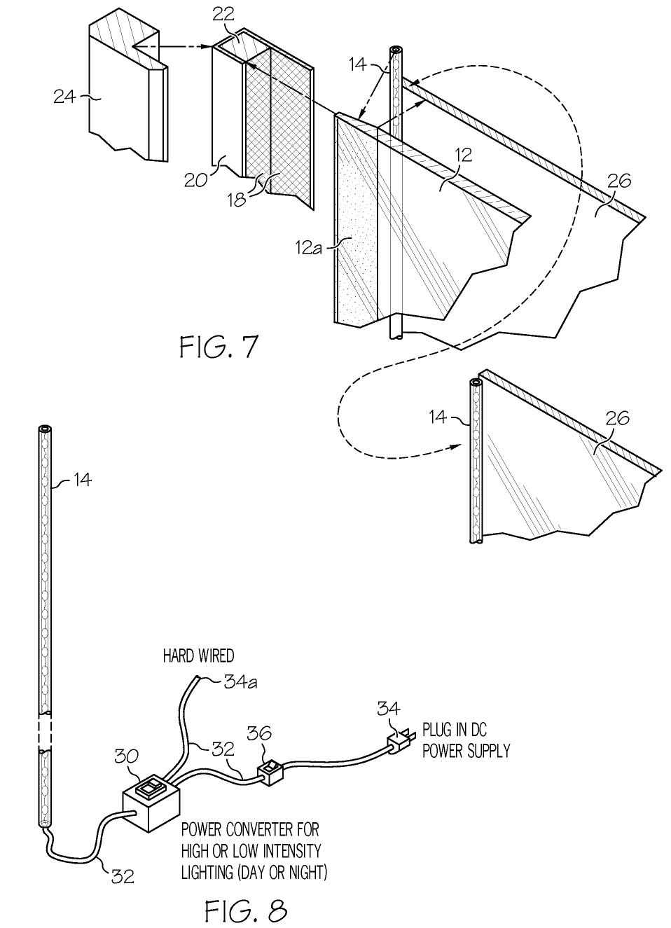

Referring to FIG. 7, the LED lighting strip 14 may be hard-wired to an electrical system 34a or may be connected to standard household power with plug 34 on the end of the cord 32. The day/night switch 30 may be part of a power converter that converts AC power to DC power.

While glass has been described here, any transparent or translucent material may be used in various embodiments of the present invention. For example, acrylic may be used in place of glass. The translucence or opacity of the rear-side beveled areas may be by varied by use of surface treatment procedures, including but not limited to chemical etching, grinding, and sandblasting.

Mirroring treatment may be applied to rear of glass surface. The variable width rear periphery of the mirror may be beveled so that the outboard periphery of the mirror is thinner toward the edge. The outboard edges are typically not pointed/sharp, but may be flat. Variable translucence (“frosting”) of the outboard periphery may be applied by means of etching chemicals, sandblasting, or grinding and polishing techniques. LED light strips or filaments may be fastened onto the rear frosted areas. An edging may be applied to the mirror's circumference or periphery, which may protect the beveled edge and help provide a sharp outboard edge to the light field emitted by the mirror. The mirror may be connected to a direct current power converter and control unit via a cord. Alternatively, power may be supplied by one or more batteries or a USB cable. Depending upon its application, the mirror may be portable or hard-wired into a wall or other surface, or incorporated into conventional or pocket door.

The mirror itself may be cut to measure so that odd shapes, thicknesses and sizes may be provided. It may be made in decorator designs. In addition, standard round, square and rectangular sizes may be available. It may be used, e.g., as a bathroom vanity mirror, a closet door dressing mirror, a make-up mirror, for aesthetic illumination, or for any other related purposes. It may be permanently hard-wired into walls or doors. It may be used for domestic or commercial purposes. It may be portable in smaller sizes. It may be fabricated with a wide variety of LED lighting, including lighting which changes from day to night intensity, or even changes color. The mirror may include a motion sensor to automatically turn the LED lighting on and off depending on the presence of a user in the vicinity of the mirror.

The mirror of the present invention may be built with decorative edge treatments/framing, and with different grades and colors of glass. The viewing surface may be provided with different aesthetic treatments. The mirror may be intended to be used domestically as a make-up or dressing mirror, or for aesthetic lighting needs. The mirror may be intended to be used commercially as a dressing area mirror or a makeup counter mirror or, e.g., as lighting in a lobby, elevator, club or bar. It may also be used for purely aesthetic purposes.

An embodiment of the present invention includes a peripheral back-lit, focused light mirror system which may be used for home and commercial use. A lighting system, according to an embodiment of the present invention, may replace traditional overhead or wall-mounted lighting, which may not properly illuminate the subject in the mirror. The lighting system of the present invention may provide abundant lighting where there is none, or where lighting is insufficient by using rear-side peripheral light, for example, emitted from one or more light emitting diode (LED) strips or filament lighting. The light system of the present invention may focus light directly in front of the mirror at an optimum, pre-determined distance based upon intended use (i.e., make-up mirror distance versus dressing mirror distance); may eliminate the need to constantly replace conventional light bulbs; may eliminate the heat, shock, and fire hazards of conventional light bulbs; may be available in virtually all sizes and shapes; may be adjustable with simple controls to provide true “day” or “night” light levels; and may be suitable for “hard-wiring” in place when used as, e.g., a bathroom vanity mirror, a closet dressing mirror, or in commercial applications. Because its intensity is variable, and it uses highly efficient LEDs, the lighting system of the present invention may also provide night lighting. Because the LED lighting is optically correct, the effect of natural sunlight may be duplicated without the glare of light bulbs or the destructive effects of natural light's ultraviolet wavelength components.

The lighting system of the present invention may employ a mirror (which is may be flat or concave, for example) that may focus adjustable day/night LED-sourced light through at least a portion of the mirror's beveled periphery at a pre-determined target distance in front of the mirror. The back-side bevel may be cut at a pre-determined angle best suited to focus the light at the desired target distance. For example a 24 inch by 30 inch by ¼ inch plate glass vanity makeup mirror may have a 15 degree bevel to obtain a target focal length of 30-32 inches. This peripheral lighting system will fully illuminate the target, present a true picture of clothing colors and make-up, eliminate the need for overhead lighting, and eliminate the need for old-fashioned, separate lighting. The lighting system of the present invention may also be portable.

Instead of relying on, e.g., a concave mirror with unfocused exterior peripheral lighting, the lighting system of the present invention may focus light at an optimum distance while retaining an undistorted flat mirror surface. In addition, because the system may contain LED lighting elements, it may eliminate the need for separate light and mirror fixtures, and may function as a room light separate from its function as an illuminated mirror. For example, the lighting system could be used to illuminate a hotel bathroom where there is no natural light. The energy and costs savings of the LED lighting may be enormous when compared to conventional light bulbs.

The present mirror lighting system may include a mirror with beveled rear-side edges cut at a pre-determined angle which may focus light at a pre-determined target distance in front of the mirror. This rear-side bevel angle may differ depending on the distance for which the mirror is used, e.g., a make-up mirror or a closet door dressing mirror. The beveled rear-side surfaces may be frosted to create a non-glare, translucent path for a rear-mounted light, such as one or more LED strips or filament light sources. The rear-mounted, day/night adjustable intensity LED light strips or filaments may be mounted around at least a portion of the periphery of the mirror, directly behind the frosted beveled surfaces. A lightweight metal framing may be used around the outside periphery of the mirror to help maintain and “edge” the inward focus of the lighting. A simple “on-off” control mechanism may be provided to turn the light on and off while an additional switch may be provided to enable the user to change the LED lighting from “day” to “night” intensity settings. A power source, such as a direct current (DC) power converter, may be provided to convert standard alternating current (AC) power to DC power.

This present system may be called a “corona system” or a “corona light” because illuminating the mirror's LED lighting, which may be installed about a periphery of the mirror, creates a visual image which may be similar in appearance to the sun's corona during a total solar eclipse.

The use of back-mounted lighting is not intended to be ornamental, e.g., LED lights sparkling through pinholes on the outer surface. Instead, the back-mounted lighting is integral to the lighting system of the present invention, which may be intended to strongly illuminate a target in front of the mirror by passing light through a frosted, angled portion of the mirror. The LED light strips or filaments may be adjustable for intensity, i.e., day or night settings, and may be fastened to the back of the mirror on beveled edges. These beveled edges may be frosted to render them translucent and eliminate hot spots of glare. The LED light strips on the back of the mirror may shine through the frosted edges of the mirror. Because the mirror's rear edges are beveled at a predetermined angle, they may focus the light transmitted through the frosting at a desired target distance from the mirror. The target distance, or focus distance, can best be described as a plane parallel to the mirror's surface which cuts through the light field at a predetermined distance dictated by the mirror's intended use. In a square or rectangular mirror, the focused light field may be a four-sided pyramid shape where the target distance plane intersects the light field below the pyramid's vertex.

The DC electrical system may be connected to the mirror by a cord. The mirror may be hardwired into a door or wall. Alternately, the mirror may be portable and mounted on a frame. The use of a DC powered LED system may save electricity, cut operational costs, and reduce heat as compared to traditional lighting. The LED system may eliminate the need to purchase and change light bulbs.

A simple control unit may be installed on the edge of a closet door, on a nearby wall, or in the base of a portable unit. This control may be a switch of any kind, including those operated by mere bodily touch, or a rheostat. This unit may allow the user to choose between on-off, and day and night settings. The control unit may use safe, low voltage DC electrical power.

The present invention may be used for surveillance through a one-way mirror with peripheral illumination. This would include the use of video or photographic equipment. In photography, a camera may use the corona lighting system of the present invention instead of a flash device to photograph the subject through the mirror while the subject selects an optimum pose using the mirror. Use of this system may eliminate inconsistent conventional flash lighting while also providing natural wavelength lighting. This lighting system may be particularly suitable for commercial digital photography portraiture. The present invention may replace separate light fixtures in areas lacking natural sunlight such as hotel bathrooms, or residential closets. This may eliminate the cost of separate electric fixtures and their associated wiring, circuits, and fuses.

It should be understood, of course, that the foregoing relates to exemplary embodiments of the invention and that modifications may be made without departing from the spirit and scope of the invention as set forth in the following claims.

We claim:

1. A lighting system comprising:
a translucent panel having a rear-side beveled edge on at least two opposite sides of an outer periphery thereof; and
a light source positioned adjacent to the rear-side beveled edge;
wherein light rays from the light source focus at a vertical line, a horizontal line, a plane or a point located a predetermined distance from the translucent panel.

2. The lighting system of claim 1, wherein the translucent panel is a mirror.

3. The lighting system of claim 1, wherein the light source is an LED lighting strip.

4. The lighting system of claim 1, further comprising a non glare frosted coating applied to the rear-side of the rear-side beveled edge.

5. The lighting system of claim 1, further comprising a day/night switch, wherein the day/night switch adjusts the output of the light source between a high output and a low output.

6. The lighting system of claim 2, wherein the predetermined distance is a typical distance for a user to be located from the mirror when using the mirror.

7. The lighting system of claim 1, further comprising an on/off switch for interrupting power to the light source.

8. The lighting system of claim 1, wherein the rear-side beveled edge circumscribed the entire outer periphery of the translucent panel.

9. The lighting system of claim 2, wherein the mirror is selected from the group consisting of a vanity mirror, a dressing room mirror, a closet mirror and a makeup mirror.

10. The lighting system of claim 1, wherein the light source is hard-wired to an electrical power system.

11. The lighting system of claim 1, wherein the light source is electrically connected to a cord having a plug at an end thereof, wherein the plug connects to a standard electrical outlet.

12. A mirror comprising:
a translucent panel having a rear-side beveled edge on at least two opposite sides of an outer periphery thereof;
a mirroring surface on a rear side of the translucent panel, the mirroring surface being absent from the rear-side beveled edge; and
a LED lighting strip positioned adjacent to the rear-side beveled edge;
wherein light rays from the light source focus at a point, line or plane located a predetermined distance from the translucent panel.

13. The mirror of claim 12, further comprising a backing material attached to a rear surface of the mirroring surface.

14. The mirror of claim 12, wherein the translucent panel is glass.

15. The lighting system of claim 12, further comprising a non glare frosted coating applied to the rear-side of the rear-side beveled edge.

16. The lighting system of claim 12, further comprising a day/night switch, wherein the day/night switch adjusts the output of the light source between a high output and a low output.

17. The lighting system of claim 12, wherein the rear-side beveled edge is beveled at an angle from about 10 to about 30 degrees.

18. A method for illuminating a subject, the method comprising:
passing light rays from a light source through a rear-side beveled edge of a mirror; and
focusing the light rays onto the subject situated in front of the mirror;
wherein the light rays are focused to a focal point line or plane located a predetermined distance from the mirror, wherein the predetermined distance is determined from an angle of the rear-side beveled edge.

19. The method of claim 18, further comprising:
brightly illuminating the subject by selecting a day selection on a day/night switch; and
dimly illuminating the subject by selecting a night selection on the day/night switch.

20. The method of claim 18, further comprising frosting the rear-side of the rear-side beveled edge.
